(19) United States
(12) Patent Application Publication
(10) Pub. No.: US 2026/0048561 A1
(43) Pub. Date: Feb. 19, 2026

(54) REPAIR DELAMINATION IN THERMOPLASTIC COMPONENT WITH HORIZONTAL ULTRASONIC WELDING

(71) Applicant: Rohr, Inc., Chula Vista, CA (US)

(72) Inventors: Shyan Bob Shen, San Diego, CA (US); Taylor Mehelic, Homeland, CA (US); Michael van Tooren, San Diego, CA (US)

(21) Appl. No.: 18/808,947

(22) Filed: Aug. 19, 2024

(51) Int. Cl. B29C 73/34; B29L 31/30; B64F 5/40

(52) U.S. Cl. CPC B29C 73/34; B64F 5/40; B29L 2031/3076

(57) ABSTRACT

A repair method is provided during which an ultrasonic horn is arranged on a thermoplastic component. The thermoplastic component extends vertically between a first surface and a second surface. The thermoplastic component includes a delamination disposed vertically between the first surface of the thermoplastic component and the second surface of the thermoplastic component. The ultrasonic horn horizontally overlaps the delamination. The thermoplastic component is horizontal ultrasonic welded using the ultrasonic horn to repair the delamination.

### BACKGROUND

### 1. Technical Field

This disclosure relates generally to welding and, more particularly, to ultrasonic welding thermoplastic material.

### 2. Background Information

A known repair of delamination and edge damage on thermoset composites is resin injection. Resin injection, however, cannot readily be applied on thermoplastic composites. While delamination and edge damage on thermoplastic composites may be repaired using reconsolidation (e.g., with heater blankets and vacuum bags), such reconsolidation repairs may be time-consuming. In addition, heating through-the-thickness on large areas can cause thermal damage in the adjacent parts of the structure. There is a need in the art therefore for improve methods and systems for repairing thermoplastic components with delamination and/or edge damage.

### SUMMARY OF THE DISCLOSURE

According to an aspect of the present disclosure, a repair method is provided during which an ultrasonic horn is arranged on a thermoplastic component. The thermoplastic component extends vertically between a first surface and a second surface. The thermoplastic component includes a delamination disposed vertically between the first surface of the thermoplastic component and the second surface of the thermoplastic component. The ultrasonic horn horizontally overlaps the delamination. The thermoplastic component is horizontal ultrasonic welded using the ultrasonic horn to repair the delamination.

According to another aspect of the present disclosure, another repair method is provided during which an ultrasonic horn is arranged on a thermoplastic component. The thermoplastic component extends vertically between a first surface and a second surface. The thermoplastic component includes a first layer, a second layer and a damaged region where the first layer separates from the second layer at a location vertically between the first surface of the thermoplastic component and the second surface of the thermoplastic component. The ultrasonic horn horizontally overlaps the damaged region. The thermoplastic component is ultrasonic welded using the ultrasonic horn to bond the first layer to the second layer within the damaged region. The ultrasonic horn vertically engages the second surface of the thermoplastic component. The ultrasonic horn moves horizontally back-and-forth along the second surface of the thermoplastic component during the ultrasonic welding of the thermoplastic component.

According to still another aspect of the present disclosure, another repair method is provided during which an ultrasonic horn is arranged on a thermoplastic component. The thermoplastic component extends vertically between a first surface and a second surface. The thermoplastic component includes a first layer, a second layer and a damaged region where the first layer is unbonded from the second layer at a location vertically between the first surface of the thermoplastic component and the second surface of the thermoplastic component. The ultrasonic horn horizontally overlaps the damaged region. The thermoplastic component is ultrasonic welded using the ultrasonic horn to bond the first layer to the second layer within the damaged region. The ultrasonic horn vertically engages the second surface of the thermoplastic component. The ultrasonic horn moves horizontally back-and-forth along the second surface of the thermoplastic component during the ultrasonic welding of the thermoplastic component.

The location where the first layer is unbonded from the second layer may be embedded within the thermoplastic component.

The location where the first layer is unbonded from the second layer may be at a horizontal end of the thermoplastic component.

The location where the first layer separates from the second layer may be embedded within the thermoplastic component.

The location where the first layer separates from the second layer may be at a horizontal end of the thermoplastic component.

The first layer and the second layer may each include a thermoplastic matrix and fiber reinforcement embedded within the thermoplastic matrix.

The thermoplastic component may also include a first layer and a second layer vertically adjacent the first layer. The delamination may include a region in the thermoplastic component where the first layer has separated from the second layer. The horizontal ultrasonic welding may include welding the first layer to the second layer along the region using the ultrasonic horn.

The thermoplastic component may also include a first layer and a second layer vertically adjacent the first layer. The delamination may include a region in the thermoplastic component where the first layer has de-bonded from the second layer. The horizontal ultrasonic welding may include welding the first layer to the second layer along the region using the ultrasonic horn.

The delamination may be embedded within the thermoplastic component.

The delamination may extend horizontally to an end of the thermoplastic component.

The ultrasonic horn may extend along a horizontal centerline. A face of the ultrasonic horn may extend horizontally along the horizontal centerline and may vertically engage the thermoplastic component. The ultrasonic horn may move horizontally back and forth along the horizontal centerline during the horizontal ultrasonic welding.

The face of the ultrasonic horn may engage the second surface of the thermoplastic component. The horizontal centerline may be parallel to the second surface of the thermoplastic component.

The ultrasonic horn may contact the second surface of the thermoplastic component during the horizontal ultrasonic welding.

The thermoplastic component may include a thermoplastic matrix and fiber reinforcement embedded within the thermoplastic matrix.

The thermoplastic component may be configured as or otherwise include a component of an aircraft.

The repair method may also include arranging the thermoplastic component on a component support prior to the arranging of the ultrasonic horn on the thermoplastic component. The thermoplastic component may be disposed vertically between and engaged with the component support and the ultrasonic horn during the horizontal ultrasonic welding.

The horizontal ultrasonic welding may be performed at a single location horizontally along the thermoplastic component to repair the delamination.

The horizontal ultrasonic welding may be performed at multiple locations horizontally along the thermoplastic component to repair the delamination.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a schematic illustration of an aircraft.

FIG. 2 is a partial schematic sectional illustration of a repaired aircraft component.

FIG. 3 is a flow diagram of a method for repairing a thermoplastic component such as a damaged aircraft component constructed from thermoplastic composite material.

FIG. 4 is a partial schematic sectional illustration of the damaged aircraft component.

FIGS. 5 and 6 are partial schematic sectional illustrations of the damaged aircraft component with a damaged region at various locations within the component.

FIG. 7 is a partial schematic illustration of a system for ultrasonic welding the damaged aircraft component to repair the damaged region.

FIGS. 8 and 9 are plan view illustrations of an ultrasonic horn over the damaged aircraft component at one or more weld locations.

### DETAILED DESCRIPTION

The present disclosure includes methods and systems for remanufacturing, fixing and/or otherwise repairing a thermoplastic component such as a thermoplastic composite component of an aircraft. These repair methods and systems may be utilized to restore one or more features of the aircraft component to usable condition, brand new condition, similar to brand new condition, better than brand new condition, etc.

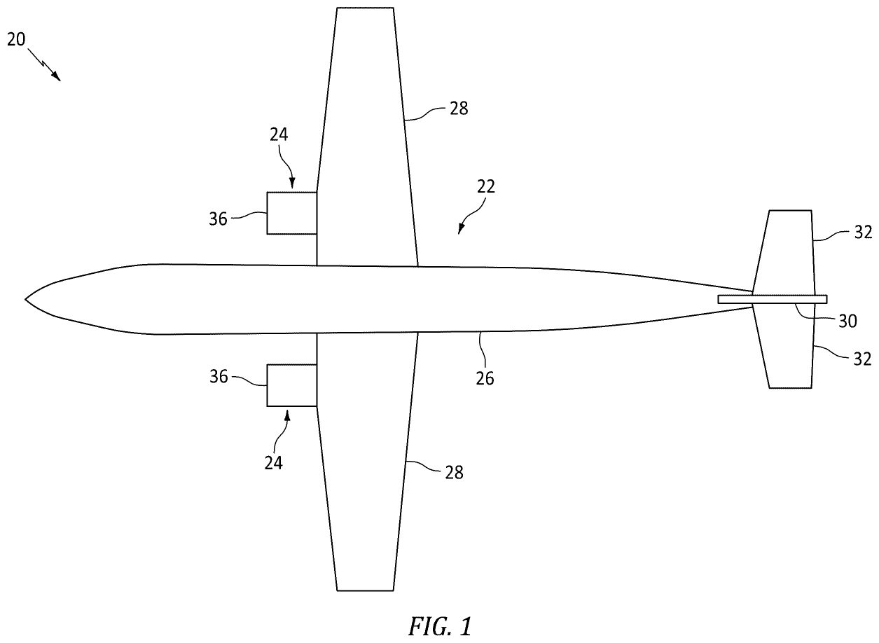

The aircraft may be an airplane, a helicopter, a drone (e.g., an unmanned aerial vehicle (UAV)), a missile, a rocket, or any other manned or unmanned aerial or aerospace vehicle or system. However, for ease of description, the aircraft may be generally described below as an airplane. An exemplary embodiment of such an aircraft 20 is shown in FIG. 1. This aircraft 20 includes an airframe 22 and one or more propulsion systems 24. The aircraft airframe 22 of FIG. 1 includes a fuselage 26, one or more wings 28, and one or more stabilizers 30 and 32. Each aircraft propulsion system 24 may include a power unit partially or completely housed within a nacelle 36. Examples of the power unit include, but are not limited to, a turbofan engine, a turboprop engine, a turbojet engine, a turboshaft engine, a rotary engine (e.g., a Wankel engine), a reciprocating piston engine, a hybrid powerplant and an electric motor.

The repair methods of the present disclosure may be used to repair various aircraft components. Such an aircraft component, for example, may be configured as or otherwise included as part of the aircraft fuselage 26, one of the aircraft wings 28, the vertical aircraft stabilizer 30, one of the horizontal aircraft stabilizers 32, the propulsion system nacelle 36, or any other composite thermoplastic member of the aircraft 20.

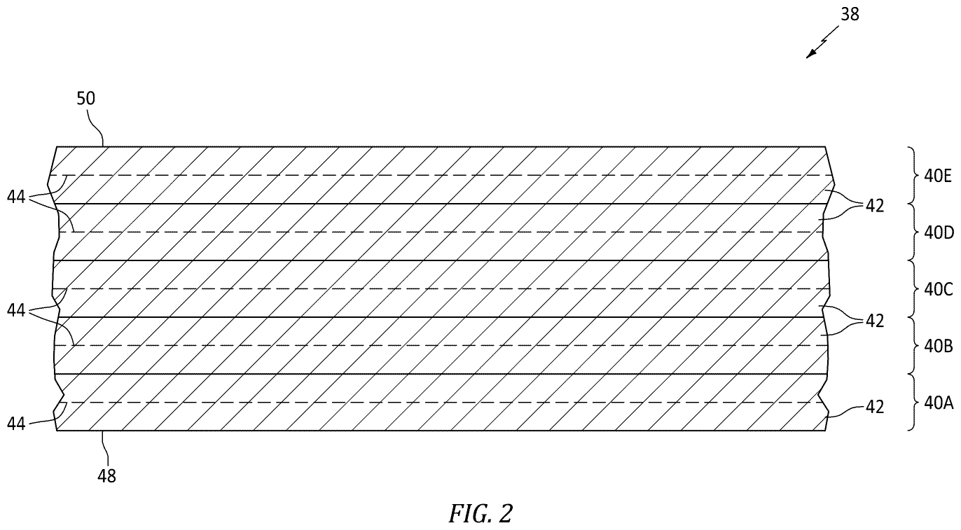

FIG. 2 schematically illustrates a repaired aircraft component 38—the aircraft component following performance of the repair thereon. This repaired aircraft component 38 is formed from one or more consolidated layers 40A-E (generally referred to as “40”) of thermoplastic material. For case of description, the thermoplastic material may be described below as thermoplastic material with fiber reinforcement—thermoplastic composite material. However, it is contemplated the thermoplastic material of one or more of the component layers 40 may alternatively be configured without fiber reinforcement.

Each component layer 40 of FIG. 2 includes a thermoplastic matrix 42 and fiber reinforcement 44 embedded within the thermoplastic matrix 42. The thermoplastic matrix 42 is a thermoplastic material (e.g., a thermoplastic resin) such as, but not limited to, thermoplastic film polyamide (PA), polyamide-imide (PAI), polyarylsulfone (PAS), polyethersulfone (PES), polyoxymethylene (POM), polyphenylene sulfide (PPS), polyether ether ketone (PEEK), polyetherimide (PEI), polyethylene terephthalate (PET), polyphthalamide (PPA), poly ether ketone ketone (PEKK), or poly aryl ether ketone (PAEK). The fiber reinforcement 44 may be or otherwise include fiberglass fibers, carbon fiber fibers, aramid (e.g., Kevlar®) fibers and/or the like. This fiber reinforcement 44 may be arranged as a (e.g., unidirectional, woven or unwoven) sheet of fibers and/or chopped fibers. The present disclosure, however, is not limited to such exemplary materials nor such a layered construction. One or more of the component layers 40, for example, may be configured without the fiber reinforcement 44.

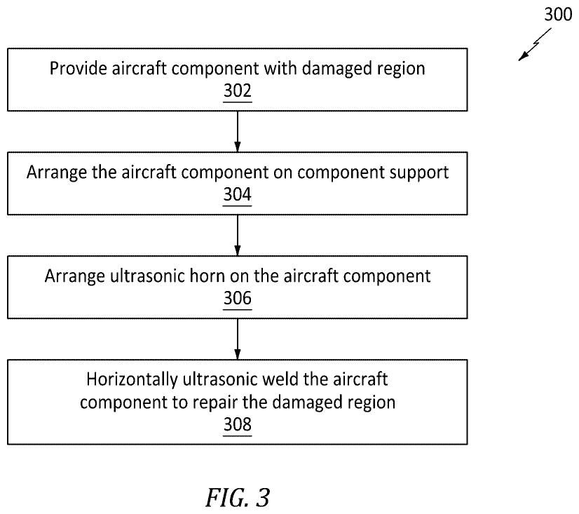

FIG. 3 is a flow diagram of a method 300 for remanufacturing, fixing and/or otherwise repairing a thermoplastic component. For ease of description, the repair method 300 is described below with respect to the repaired aircraft component 38 of FIG. 2. The repair method 300 of the present disclosure, however, may alternatively be used to repair various other types and/or structural configurations of aircraft components.

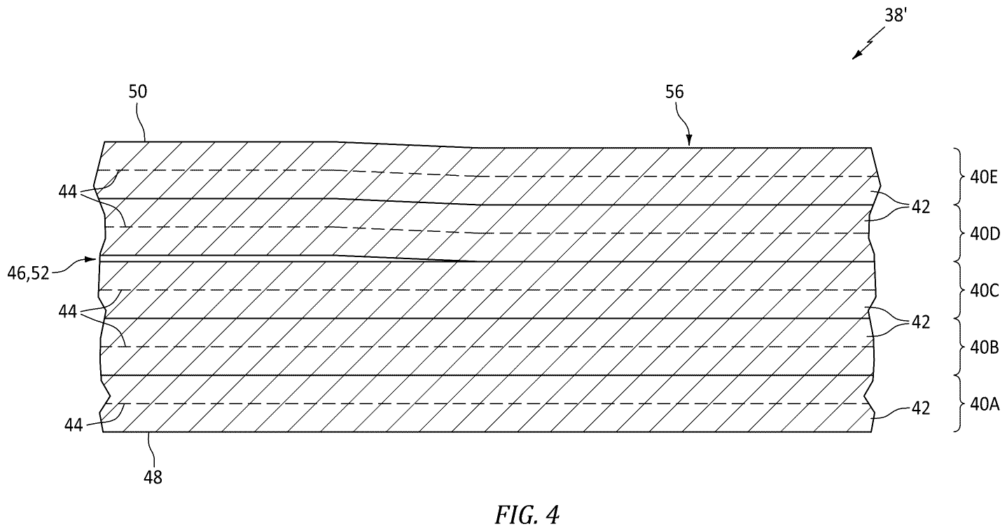

In step 302, referring to FIG. 4, the aircraft component (prior to its repair) is provided. Here, the aircraft component is a damaged aircraft component 38′. The damaged aircraft component 38′ of FIG. 4, for example, includes a damaged region 46 located within a vertical thickness of the damaged aircraft component 38′, vertically between opposing surfaces 48 and 50 of the damaged aircraft component 38′. This damaged region 46 corresponds to an area within the damaged aircraft component 38′ exhibiting delamination 52 between two or more of the component layers 40. The damaged aircraft component 38′ of FIG. 4, for example, includes the component layer 40C and the component layer 40D disposed vertically adjacent and horizontally overlapping the component layer 40C. While a majority (e.g., more than 90% or 95%) of the component layer 40C is bonded to and consolidated with the component layer 40D (e.g., outside of the damaged region 46), a small portion of the component layer 40C within the damaged region 46 may be vertically separated from (e.g., lifted away from) and/or de-bonded (e.g., unbonded) from a corresponding portion of the component layer 40D. This delamination 52 may reduce a structural integrity of the damaged aircraft component 38′.

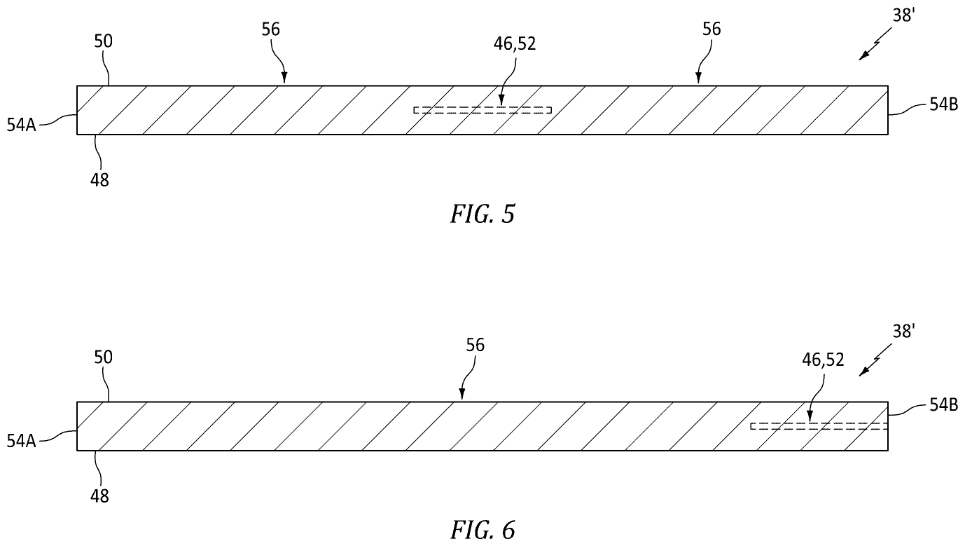

Referring to FIG. 5, the damaged region 46 and its delamination 52 may be (e.g., completely) embedded within the damaged aircraft component 38′. The damaged region 46 and its delamination 52 of FIG. 5, for example, are horizontally spaced from each horizontal end 54A, 54B (generally referred to as “54”) of the damaged aircraft component 38′ by a respective undamaged region 56 of the damaged aircraft component 38′. Each undamaged region 56 corresponds to an area within the damaged aircraft component 38′ where, for example, the component layer 40C is bonded to and consolidated with the component layer 40D (see FIG. 4). Alternatively, referring to FIG. 6, the damaged region 46 and its delamination 52 may be disposed at one of the horizontal ends 54 (and/or a corner) of the damaged aircraft component 38′. The damaged region 46 and its delamination 52 of FIG. 6, for example, extend to the respective horizontal end 54B of the damaged aircraft component 38′. However, for case of description, the damaged region 46 and its delamination 52 may be generally described below as being embedded within the damaged aircraft component 38′ as generally shown in FIG. 5.

In some cases, the damage/delamination to the aircraft component may occur/be present during the manufacturing process of the aircraft component. In such cases, the damaged aircraft component 38′ may be received following an inspection of that aircraft component. In other cases, the damage/delamination to the aircraft component may occur during installation of the aircraft component and/or during aircraft operation; e.g., aircraft flight, aircraft takeoff, aircraft landing, etc. In such cases, the damaged aircraft component 38′ may be removed from the aircraft 20 for the repair method 300. Alternatively, it is contemplated the repair method 300 may alternatively be performed on-wing. The damaged aircraft component 38′, for example, may remain installed with the aircraft 20 (or installed with a respective module of the aircraft 20). However, for ease of description, the repair method 300 is described below with the damaged aircraft component 38′ discrete from other aircraft components.

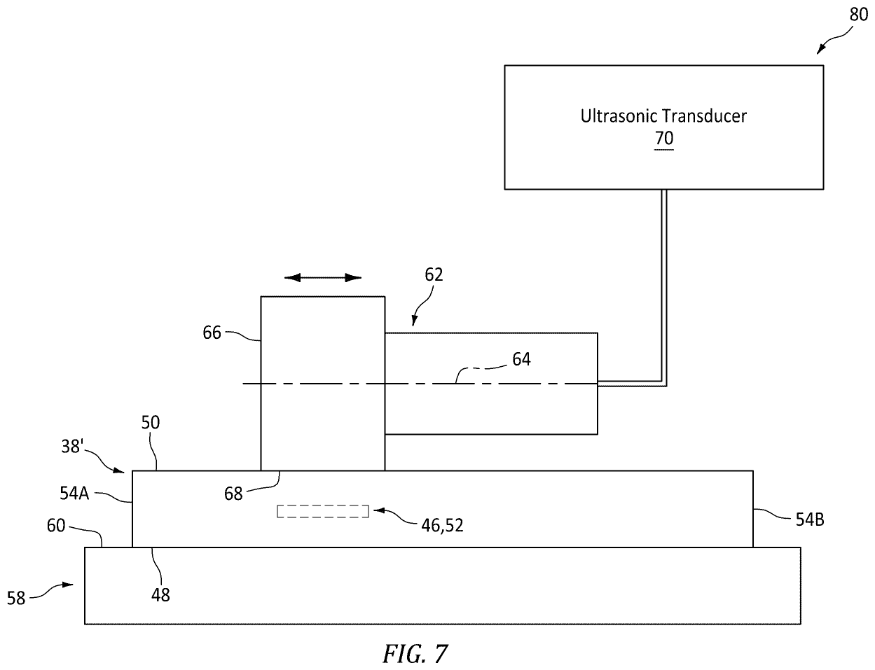

In step 304, referring to FIG. 7, the damaged aircraft component 38′ may be arranged on a component support 58. The damaged aircraft component 38′ of FIG. 7, for example, is disposed on top of the component support 58 with the component bottom surface 48 vertically engaging (e.g., contacting, abutted against, etc.) a top surface 60 of the component support 58. The component bottom surface 48, for example, may lay against (e.g., rest on, be disposed in full contact with, be disposed flat against, etc.) the support top surface 60. Herein, the terms “top” and “bottom” may describe relative vertical positions of an element during the illustrated repair method 300. However, it is contemplated the element may be alternatively oriented when assembled with the aircraft 20. Moreover, it is contemplated the element may be alternatively oriented during alternative embodiments of the repair method 300. Referring again to FIG. 7, the damaged aircraft component 38′ may be (e.g., temporarily) secured to the component support 58 by a fixture, or the damaged aircraft component 38′ may simply rest unrestrained against the component support 58. The component support 58 may be configured as or otherwise include a die, an anvil, a mandrel, a table or other tooling. Of course, where the damaged aircraft component 38′ is capable of being self-supported during the repair method 300, this step 304 may be omitted facilitating repair while the damaged aircraft component 38′ remains installed with the aircraft 20, for example.

While the surfaces 48 and 60 are shown with straight-line sectional geometries in the plane of FIG. 7, it is contemplated the surfaces 48 and 60 may alternatively have non-straight-line (e.g., curved, compound, etc.) sectional geometries in the plane of FIG. 7. Moreover, the surfaces 48 and 60 may also or alternatively have straight-line or non-straight-line sectional geometries in a plane perpendicular to the plane of FIG. 7. For example, the surfaces 48 and 60 may be flat, planar surfaces, two-dimensional (2D) curved or otherwise non-flat surfaces, or three-dimensional (3D) curved or otherwise non-flat surfaces.

In step 306, an ultrasonic horn 62 (e.g., a sonotrode) used for the ultrasonic welding is arranged on the damaged aircraft component 38′. The ultrasonic horn 62 extends horizontally along a horizontal centerline 64 of the ultrasonic horn 62 to a distal end 66 of the ultrasonic horn 62. At a bottom side of the ultrasonic horn 62 and adjacent the distal end 66, the ultrasonic horn 62 has a face 68 (e.g., an engagement surface) which extends horizontally along and is parallel with the horn centerline 64. The horn face 68 is positioned vertically over the damaged aircraft component 38′. The horn face 68 engages (e.g., fully contacts) the damaged aircraft component 38′ and its component top surface 50. With this arrangement, the ultrasonic horn 62 extends horizontally along the damaged aircraft component 38′ and its component top surface 50. The horn centerline 64 may thereby be substantially (e.g., within 2-5 degrees of) or completely parallel with the component top surface 50. The ultrasonic horn 62 of FIG. 7 is further operatively coupled to an ultrasonic transducer 70 of a horizontal ultrasonic welder 80.

While the surface 50 is shown with straight-line sectional geometry in the plane of FIG. 7, it is contemplated the surface 50 may alternatively have a non-straight-line (e.g., curved, compound, etc.) sectional geometry in the plane of FIG. 7. Moreover, the surface 50 may also or alternatively have a straight-line or a non-straight-line sectional geometry in a plane perpendicular to the plane of FIG. 7. For example, the surface 50 may be a flat, planar surface, a two-dimensional (2D) curved or otherwise non-flat surface, or a three-dimensional (3D) curved or otherwise non-flat surface.

In step 308, the damaged aircraft component 38′ is horizontal ultrasonic welded to repair the damaged region 46 and its delamination 52 using the horizontal ultrasonic welder 80. The ultrasonic transducer 70 of the horizontal ultrasonic welder 80, for example, is configured to move (e.g., translate, oscillate, etc.) the ultrasonic horn 62 back-and-forth horizontally along the horn centerline 64 during the ultrasonic welding. This movement of the ultrasonic horn 62 heats the thermoplastic matrix 42 of FIG. 4 in the damaged aircraft component 38′ and its delaminated component layers 40C and 40D. The heating softens and then locally melts the thermoplastic matrix 42 and thereby (e.g., spot) welds the delaminated component layers 40C and 40D together at and about a point horizontally aligned with the ultrasonic horn 62 and its horn face 68; e.g., at a weld location. The horizontal ultrasonic welding may thereby bond and consolidate the previously delaminated component layers 40C and 40D together to provide the repaired aircraft component of FIG. 2.

In one embodiment, edge damage (e.g., to simulate the damaged region 46 and its delamination 52) was intentionally created in a thermoplastic matrix material (e.g., to simulate the damaged aircraft component 38′). 12-inch by 12-inch by 0.09-inch carbon-fiber-reinforced PAEK thermoplastic matrix material (CETEX® TC1225 sold by Toray Advanced Composites Netherlands B.V., Netherlands) panels were consolidated with a pair of 0.005-inch-thick steel shim inserted between the center layers. After consolidation, the steel shims were pulled out from the consolidated panel to create the artificial edge damage (e.g., to simulate the damaged region 46 and its delamination 52). The shape of the artificial edge damage caused by the steel shims is an isosceles trapezoid with parallel sides of length 1-inch and 0.5-inch and each having a height of 0.5-inch. The panel was inspected by computed tomography X7500 (by North Star Imaging located in Rogers, Minnesota, USA) to record the edge damage location and dimension. A horizontal ultrasonic welding repair such as that described above was performed using an MPX5000 Welding System with a 7.2 KW generator (by Telsonic Ultrasonic, Bronschhofen, Switzerland) (e.g., as an exemplary embodiment of the horizontal ultrasonic welder 80) with a 0.57-inch (1.45 centimeters) square sonotrode at a weld load of 370 pounds (168 kilograms), a weld energy of 1500 joules, and a weld time of 2.0 seconds plus a hold time of 5.5 seconds. Following the repair, the repaired panels were inspected with computed tomography to record the edge damage location and dimension. As compared between the edge damage location and dimension before and after the repair, the results showed the edge damage was completely recovered and the void disappeared, at the 50% depth layer.

In another embodiment, a 30-joules impact damage (e.g., e.g., to simulate the damaged region 46 and its delamination 52) was intentionally created in a thermoplastic matrix material (damaged aircraft component 38′). 7-inch by 4-inch by 0.092-inch carbon-fiber-reinforced PAEK thermoplastic matrix material (CETEX® TC1225 sold by Toray Advanced Composites Netherlands B.V., Netherlands) panels were consolidated. After consolidation, a low velocity impact device with a 1.0-inch (2.54 centimeters) diameter tip was used to create the center impact damage (e.g., to simulate the damaged region 46 and its delamination 52). The panel was inspected by computed tomography X7500 (by North Star Imaging located in Rogers, Minnesota, USA) to record the edge damage location and dimension. Multiple layers of delamination caused by the 30-joules impact were observed at between 70% to 85% depth of the thickness. A horizontal ultrasonic welding repair such as that described above was performed using an MPX5000 Welding System with a 7.2 KW generator (by Telsonic Ultrasonic, Bronschhofen, Switzerland) (e.g., as an exemplary embodiment of the horizontal ultrasonic welder 80) with a 1.0-inch (2.54 centimeters) square sonotrode, a weld load of 370 pounds (168 kilograms), a weld energy of 1500 joules, and a weld time of 5.1 seconds plus a hold time of 2.0 seconds. The repaired panels were inspected with computed tomography to record the edge damage location and dimension. As compared between the edge damage location and dimension before and after repair, the results showed all the delamination completely recovered (disappeared) through the thickness.

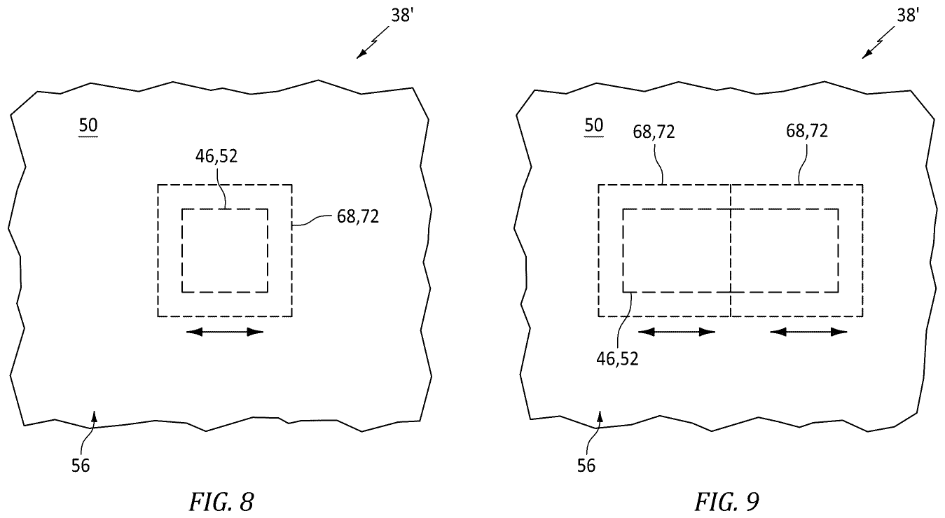

In some embodiments, referring to FIG. 8, the horizontal ultrasonic welding may be performed at a single location horizontally along the component top surface 50. A footprint 72 (e.g., area) of the horn face 68 of FIG. 8, for example, completely horizontally overlaps the damaged region 46. In other embodiments, referring to FIG. 9, the horizontal ultrasonic welding may be performed at multiple adjacent locations horizontally along the component top surface 50. The footprint 72 of the horn face 68 of FIG. 9, for example, partially horizontally overlaps the damaged region 46. The ultrasonic horn 62 is therefore moved horizontally to one or more additional locations to repair corresponding different portions of the damaged region 46. In other words, the damaged aircraft component 38′ may be spot welded at multiple locations to repair the damaged region 46 and its delamination 52.

The repair method 300 utilizes localized heating to repair the damaged region 46 and its delamination 52. This localized heating may have relatively little impact on nearby portions of the aircraft component. The repair method 300 of the present disclosure may therefore be performed without, for example, use of a heating blanket. Moreover, the repair method 300 of the present disclosure may be performed quickly; e.g., less than ten minutes depending upon the specific repair.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A repair method, comprising:
arranging an ultrasonic horn on a thermoplastic component, the thermoplastic component extending vertically between a first surface and a second surface, the thermoplastic component comprising a delamination disposed vertically between the first surface of the thermoplastic component and the second surface of the thermoplastic component, and the ultrasonic horn horizontally overlapping the delamination; and
horizontal ultrasonic welding the thermoplastic component using the ultrasonic horn to repair the delamination.

2. The repair method of claim 1, wherein
the thermoplastic component further comprises a first layer and a second layer vertically adjacent the first layer;
the delamination comprises a region in the thermoplastic component where the first layer has separated from the second layer; and
the horizontal ultrasonic welding comprises welding the first layer to the second layer along the region using the ultrasonic horn.

3. The repair method of claim 1, wherein
the thermoplastic component further comprises a first layer and a second layer vertically adjacent the first layer;
the delamination comprises a region in the thermoplastic component where the first layer has de-bonded from the second layer; and
the horizontal ultrasonic welding comprises welding the first layer to the second layer along the region using the ultrasonic horn.

4. The repair method of claim 1, wherein the delamination is embedded within the thermoplastic component.

5. The repair method of claim 1, wherein the delamination extends horizontally to an end of the thermoplastic component.

6. The repair method of claim 1, wherein
the ultrasonic horn extends along a horizontal centerline;
a face of the ultrasonic horn extends horizontally along the horizontal centerline and vertically engages the thermoplastic component; and
the ultrasonic horn moves horizontally back and forth along the horizontal centerline during the horizontal ultrasonic welding.

7. The repair method of claim 6, wherein
the face of the ultrasonic horn engages the second surface of the thermoplastic component; and
the horizontal centerline is parallel to the second surface of the thermoplastic component.

8. The repair method of claim 1, wherein the ultrasonic horn contacts the second surface of the thermoplastic component during the horizontal ultrasonic welding.

9. The repair method of claim 1, wherein the thermoplastic component includes a thermoplastic matrix and fiber reinforcement embedded within the thermoplastic matrix.

10. The repair method of claim 1, wherein the thermoplastic component comprises a component of an aircraft.

11. The repair method of claim 1, further comprising:
arranging the thermoplastic component on a component support prior to the arranging of the ultrasonic horn on the thermoplastic component;
the thermoplastic component disposed vertically between and engaged with the component support and the ultrasonic horn during the horizontal ultrasonic welding.

12. The repair method of claim 1, wherein the horizontal ultrasonic welding is performed at a single location horizontally along the thermoplastic component to repair the delamination.

13. The repair method of claim 1, wherein the horizontal ultrasonic welding is performed at multiple locations horizontally along the thermoplastic component to repair the delamination.

14. A repair method, comprising:
arranging an ultrasonic horn on a thermoplastic component, the thermoplastic component extending vertically between a first surface and a second surface, the thermoplastic component including a first layer, a second layer and a damaged region where the first layer separates from the second layer at a location vertically between the first surface of the thermoplastic component and the second surface of the thermoplastic component, and the ultrasonic horn horizontally overlapping the damaged region; and
ultrasonic welding the thermoplastic component using the ultrasonic horn to bond the first layer to the second layer within the damaged region, the ultrasonic horn vertically engaging the second surface of the thermoplastic component, and the ultrasonic horn moving horizontally back-and-forth along the second surface of the thermoplastic component during the ultrasonic welding of the thermoplastic component.

15. The repair method of claim 14, wherein the location where the first layer separates from the second layer is embedded within the thermoplastic component.

16. The repair method of claim 14, wherein the location where the first layer separates from the second layer is at a horizontal end of the thermoplastic component.

17. The repair method of claim 14, wherein the first layer and the second layer each include a thermoplastic matrix and fiber reinforcement embedded within the thermoplastic matrix.

18. A repair method, comprising:
arranging an ultrasonic horn on a thermoplastic component, the thermoplastic component extending vertically between a first surface and a second surface, the thermoplastic component including a first layer, a second layer and a damaged region where the first layer is unbonded from the second layer at a location vertically between the first surface of the thermoplastic component and the second surface of the thermoplastic component, and the ultrasonic horn horizontally overlapping the damaged region; and
ultrasonic welding the thermoplastic component using the ultrasonic horn to bond the first layer to the second layer within the damaged region, the ultrasonic horn vertically engaging the second surface of the thermoplastic component, and the ultrasonic horn moving horizontally back-and-forth along the second surface of the thermoplastic component during the ultrasonic welding of the thermoplastic component.

19. The repair method of claim 18, wherein the location where the first layer is unbonded from the second layer is embedded within the thermoplastic component.

20. The repair method of claim 18, wherein the location where the first layer is unbonded from the second layer is at a horizontal end of the thermoplastic component.
